(19) United States
(12) Patent Application Publication
(10) Pub. No.: US 2004/0123944 A1
(43) Pub. Date: Jul. 1, 2004

(54) Stamp dispenser

(76) Inventors: Kenneth Lloyd Dorrell, Kansas City, MO (US); Christopher J. Clute, Less Summit, MO (US); Mark E. Traylor, Olathe, KS (US)

Correspondence Address: FISH & RICHARDSON P.C., 3300 DAIN RAUSCHER PLAZA, 60 SOUTH SIXTH STREET, MINNEAPOLIS, MN, 55402, US

(21) Appl. No.: 10/664,035

(22) Filed: Sep. 16, 2003

Related U.S. Application Data
(60) Provisional application No. 60/411,051, filed on Sep. 16, 2002.

(51) Int. Cl. B32B 31/00

(52) U.S. Cl. 156/250; 156/257; 156/510

(57) ABSTRACT

A stamp dispenser for dispensing one or more stamps from a roll of stamps, such as a roll of liner-less adhesive-backed stamps, may include a hub member for rotatably receiving the roll of stamps and a separation member spaced apart from and coupled to the hub member. In preferred embodiments, a user may grasp the leading portion of the stamp web, pull it across the separation member, permit the underside of the stamp web to adhere to the separation member, tension the leading portion of the roll across the separating surface, and then tear the leading stamp(s) from the web. The stamp dispenser may further include a substantially cylindrical sleeve disposed between the roll of stamps and the hub member, or the roll may include a substantially cylindrical core, wherein the roll of stamps is wound around the core.

### CLAIM OF PRIORITY

This application claims priority to U.S. Provisional Patent Application Serial No. 60/411,051, filed on Sep. 16, 2002, the entire contents of which are hereby incorporated by reference.

### BACKGROUND

Postage stamps are generally manufactured in one of two basic formats. The first includes adhesive-backed stamps on a disposable backing strip or liner, which is in turn wound into a roll. Such stamps may be separated from one another by a perforation, score, or an unused portion of the backing strip. These stamps generally are self-adhesive in that a stamp may be removed from the liner and applied to another surface, such as an envelope, without applying moisture to the adhesive backing of the stamp. Examples of devices for dispensing such postage stamps are disclosed in U.S. Pat. No. 5,851,347 and U.S. Pat. No. 6,382,291. Such devices generally include a gear system that winds the backing strip to a different part of the dispenser after the self-adhesive stamp is separated from the liner and applied to a desired surface.

A second type of stamp includes liner-less adhesive-backed stamps that are separated from one another by a perforation, score, or the like, and that are wound into a roll. These stamps generally are not self-adhesive, meaning that, after removing a stamp from the roll, the user may apply moisture to the stamp to activate the adhesive before applying the stamp to another surface. However, the adhesive backings of these stamps generally are somewhat tacky, even when dry, so that they stamps may stick to one another. An example of a device for dispensing those stamps is shown in U.S. Pat. No. 4,770,322. Such a device generally includes a hinged base and cover for holding the roll of stamps, and an aperture between two planar walls for receiving the leading edge of the roll. The leading edge may be moved through the aperture by engaging a slide to push a stamp out of the dispenser.

Liner-less adhesive-backed stamps may be difficult to dispense with such an apparatus. In particular, a user may find it difficult to load a new roll, feed the leading stamps into the aperture, and properly mate the stamp web with the advancing mechanism. Moreover, the loading an operation may require that the dispenser be opened with a tool or other instrument. Such dispensing devices may be subject to jamming and permit only limited manual access to the stamp web. Removal of a leading stamp from the web of stamps may likewise be complicated by the fact that failure to apply a proper braking force to the roll of stamps will cause the web to advance during an attempt to tear a stamp away from the web.

### SUMMARY

A stamp dispenser for dispensing one or more stamps from a roll of stamps, such as a roll of liner-less adhesive-backed stamps, may include a hub member for rotatably receiving the roll of stamps and a separation member spaced apart from and coupled to the hub member. In preferred embodiments, a user may grasp the leading portion of the stamp web, pull it across the separation member, permit the underside of the stamp web to adhere to the separation member, tension the leading portion of the roll across the separating surface, and then tear the leading stamp(s) from the web. The stamp dispenser may further include a substantially cylindrical sleeve disposed between the roll of stamps and the hub member, or the roll may include a substantially cylindrical core, wherein the roll of stamps is wound around the core.

In an embodiment, the stamp dispenser includes a wall having a hub section and a forward extending section, the hub member coupled to the hub section substantially perpendicular to the wall, and the separation member coupled to the forward extending section. The stamp dispenser may also include one or more flanges coupled to the wall for retaining the roll of stamps between the flanges and the wall. The flanges may include a flexible member and a lip configured to retain the roll between the lip and the wall, as well as an extension member extending from the lip to allow a user to flex the flexible member.

As noted above, the separation surface may be configured to releasably retain a portion of the leading portion of the roll. In an embodiment, the separation surface is substantially free of sharp corners and sharp edges. The stamp dispenser may further include an interference means for preventing unraveling of the roll of stamps. The interference means may comprise, for example, a brake that is reversibly moveable between an engaged position wherein the brake engages the roll of stamps and an unengaged position wherein the brake does not engage the roll of stamps. In an embodiment, the brake may be biased in the unengaged position.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a side view of a dispensing device in accordance with one embodiment of the invention.

FIG. 2 is a perspective view of the dispensing device of FIG. 1.

FIG. 3 is another perspective view of the dispensing device of FIG. 1.

FIG. 4A is a detailed view of one embodiment of the flanges of the dispensing device of FIG. 1.

FIG. 4B is a detailed view of a second embodiment of the flanges of the dispensing device of FIG. 1.

FIG. 5 is a perspective view of dispensing device in accordance with a second embodiment of the invention.

FIG. 6 is a perspective view of a dispensing device in accordance a third embodiment of the invention.

FIG. 7 is a perspective view of a dispensing device in accordance with a fourth embodiment of the invention.

Like reference symbols in the various drawings indicate like elements.

### DETAILED DESCRIPTION OF ILLUSTRATIVE EMBODIMENTS

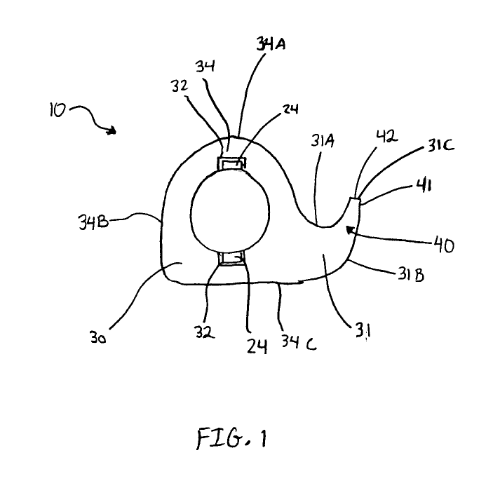

FIGS. 1-3 show a dispensing device 10 in accordance with one embodiment of the invention. In this embodiment, the dispensing device 10 is adapted to rotatably mount a substantially cylindrical roll of adhesive-backed material, such as a roll 60 of postage stamps 62, on a hub member 20 having a longitudinal axis 21. Hub member 20 can have an axial length slightly greater than the axial length of the roll 60 and a diameter slightly less than the inner diameter of the roll 60 so that the roll 60 can be rotatably mounted on hub member 20. Hub member 20 comprises a first end (hidden) coupled to a wall 30, hub member 20 extending from the wall 30 so that longitudinal axis 21 is substantially perpendicular to the wall 30.

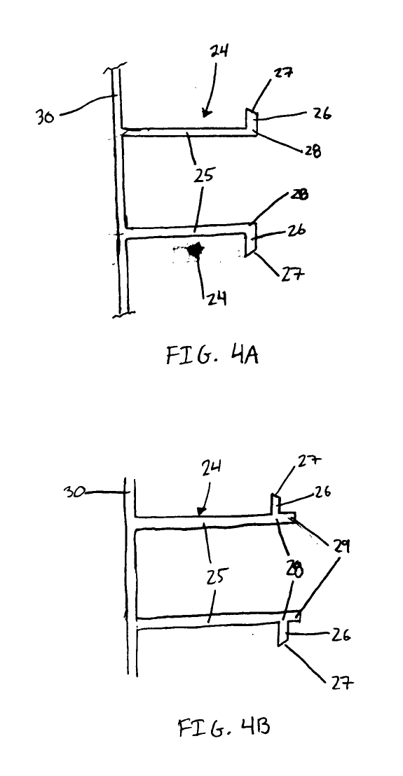

Two flanges 24 may be coupled to wall 30 and project towards a second end 22 of hub member 20 for retaining the roll 60 on the hub member 20 between flanges 24 and wall 30. FIG. 4A depicts, in cross section, a detailed view of one embodiment of flanges 24. Each flange 24 comprises a flexible member 25 extending outwardly from wall 30 so that flexible member 25 is substantially perpendicular to wall 30. Flexible member 25 may be made of a flexible material, such as plastic, metal, rubber, or the like. A lip 26 extends substantially perpendicularly from a flexible member end 28 so that roll 60 of stamps can be retained between lip 26 and wall 30. In an embodiment, lip 26 includes angled bevel 27, which is angled to facilitate inserting roll 60 over lip 26 to be retained between lip 26 and wall 30. In use, flanges 24 may be flexed towards one another to allow insertion of roll 60 over hub 20 and then released to allow roll 60 to be retained between lip 26 and wall 30.

FIG. 4B depicts, in cross section, another embodiment of flange 24. Each flange 24 comprises a flexible member 25 extending outwardly from wall 30 so that flexible member 25 is substantially perpendicular to wall 30. Flexible member 25 may be made of a flexible material, such as plastic, metal, rubber, or the like. A lip 26 extends substantially perpendicularly from a flexible member end 28 so that roll 60 of stamps can be retained between lip 26 and wall 30. In an embodiment, lip 26 includes angled bevel 27, which is angled to facilitate inserting roll 60 over lip 26 to be retained between lip 26 and wall 30. In use, flanges 24 may be flexed towards one another to allow insertion of roll 60 over hub 20. Flanges 24 then may be released to allow roll 60 to be retained between lip 26 and wall 30. In the embodiment shown in FIG. 4B, an extension member 29 also extends from an end 28 of flexible member 25. Extension member 29 allows the user to more easily flex flexible member 25, such as by using a fingernail, in order to facilitate inserting and removing roll 60 over hub member 20.

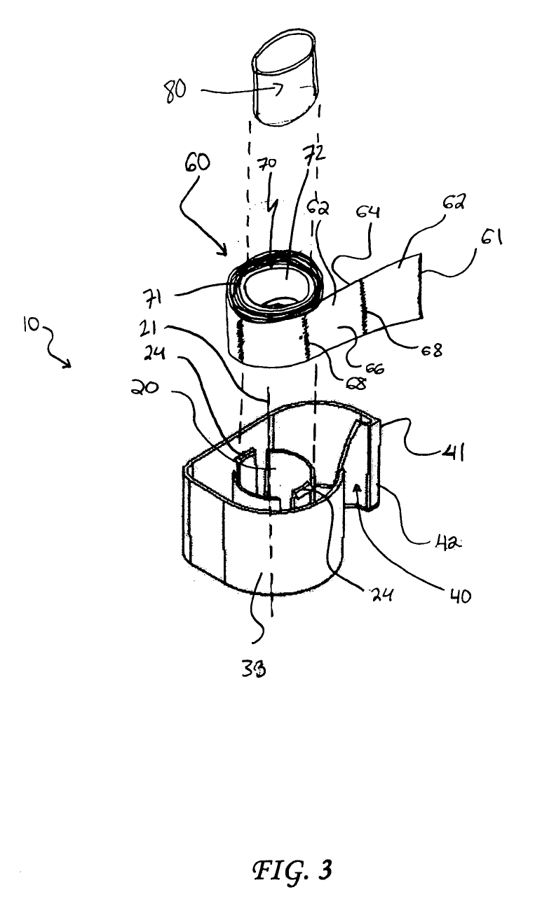

While two embodiments of flanges 24 have been depicted, flanges 24 may have other configurations that facilitate retaining roll 60 on hub member 20. In addition, while the embodiments in FIGS. 3, 4A, and 4B depict two flanges 24, hub member 20 may include one, three or more flanges. In addition, the wall 30 may include apertures 32 aligned with the flanges 24.

As shown in FIGS. 1-3, wall 30 may comprise a hub member 34 and a forward extending section 31. Hub section 34 may be defined substantially on three sides by a top edge 34A, a rear edge 34B, and a bottom edge 34C. In the embodiment shown in FIGS. 1-3, top edge 34A has a substantially arcuate shape that approximates the curvature of the roll 60, while rear edge 34B and bottom edge 34C are substantially straight and perpendicular to one another. However, top edge 34A, rear edge 34B, and bottom edge 34C could have any suitable shape and orientation, such as all being arcuate and rounded, all being straight and perpendicular, or all being straight and at acute angles to one another, such as to form a substantially triangular shape. In addition, hub section 34 may be defined by more than or fewer than three edges.

Dispenser 10 may also include a top shield 33 coupled to top edge 34A, a rear shield 51 coupled to rear edge 34B, and a base 50 coupled to a bottom edge 34C. Together with wall 30, the top shield 33, base 50, and rear shield 51 form a housing that protects roll 60 and allows the user a convenient place to hold the dispenser 10. It should be understood that hub member 20, wall 30, top shield 33, base 50, and rear wall 51 can be formed as a single piece or as multiple pieces.

Forward extending section 31 of wall 30 is generally defined by top edge 31 A and a bottom edge 31B. As shown in FIGS. 1-3, top edge 31A has a curvilinear shape and extends from top edge 34A of hub section 34. Bottom edge 31B also has a curvilinear shape that extends from bottom edge 34C of hub section 34. Top edge 31A and bottom edge 31B join at a junction 31C, which may be any suitable shape, such as a substantially straight edge, a curved edge, or a point. It should be understood, that top edge 31A, bottom edge 31B, and junction 31C may have any other suitable shape such as straight edges. In addition, forward extending section 31 may be defined by a different number of edges than those described.

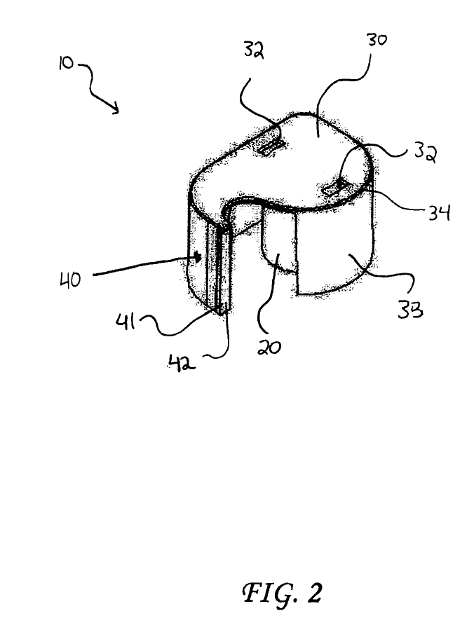

As shown in FIG. 2, coupled to forward extending section 31 of wall 30 is a separation member 40 having a substantially blunt separation surface 42. When the roll 60 is properly retained on the hub member 20, a leading portion 61 of the roll 60 may be pulled and guided across separation member 40 such that the adhesive-coated surface 64 of the roll 60 can be releasably retained upon separation surface 42. In the embodiment shown in FIGS. 1-3, separation surface 42 has a surface area sufficient for at least a portion of the adhesive-coated surface 64 of the leading portion 61 to be releasably retained thereon. Separation member 40 may further include a front end 41, which may be arcuate in shape. In the embodiment shown in FIGS. 1-3, front end 41 meets separation surface 42 such that separation surface 42 is substantially free of any sharp corners or sharp edges. In addition, separation member 40 does not include a blade, serration, or a sharp edge.

In the embodiment shown in FIGS. 1-3, roll 60 of stamps 62 is liner-less such that there is no release liner to which the stamps are initially adhered. For example, the liner-less self-adhesive stamps 62 may have an adhesive coated surface 64 and a non-adhesive surface 66. A perforation or score 68 may exist between each stamp 62 in the roll 60, so as to weaken the material between the stamps and facilitate the separation of individual stamps 62 from the roll 60.

As shown in FIG. 3, roll 60 may optionally include a hollow, substantially cylindrical core 70 about which stamps 62 are wound to form roll 60. Core 70 may include an outer surface 71 about which stamps 62 are wound and an inner surface 72 which is configured to be rotatably mounted about hub member 20. Core 70 may be comprised of any suitable material, such as cardboard, paperboard, plastic, metal, a composite, or the like. Core 70 facilitates smooth rotation of roll 60 about hub member 20 without the adhesive coated surface 64 of stamps 62 becoming stuck to or caught on hub member 20.

In addition to core 70, a sleeve 80 may be disposed between the inner surface 72 of core 70 and hub member 20 in order to further facilitate smooth rolling of roll 60 about hub member 20. Sleeve 80 may be sized and made of a material, such as plastic, to reduce the friction between core 70 and hub member 20. In another embodiment, core 70 may be omitted and sleeve 80 may be disposed between interior of roll 60 and hub member 20 to facilitate smooth rolling of roll 60 about hub member 20. It should be understood that, in embodiments in which core 70 and/or sleeve 80 are used, the diameter of the roll 60 must be larger and/or the diameter of hub member 20 must be smaller, so as to accommodate core 70 and/or sleeve 80 between roll 60 and hub member 20.

In operation and use, roll 60, which is wound around core 70, is inserted over sleeve 80. Flanges 24 are then flexed towards each other to allow sleeve 80, containing roll 60 of stamps 62, to be inserted over hub member 20. Flanges 24 are then released to rotatably retain roll 60 about hub member 20 between lips 26 of flanges 24 and wall 30. Roll 60 then may be rotated by pulling leading portion 61 of roll 60 across the separation surface 41, such that at least a first stamp 63 is guided across separation member 40 and the succeeding perforation or score 68 is aligned with or slightly over front end 41 of separation member 40. A portion of the adhesive-coated surface 64 of a second stamp 66 is then releasably retained on separation surface 40 while the first stamp 63 overhangs and projects past separation surface 42. The adherence of the second stamp 66 to separation surface 40 is sufficient to allow the user to separate first stamp 63 from the roll along perforation or score 68 by tensioning the leading edge of the roll across separation surface 42 and lightly pulling on overhanging first stamp 63. After first stamp 63 is separated from the roll 60, a new leading portion 61 is formed where the perforation or score 68 was separated. If additional stamps are to be separated from the roll 60, the user may lift the portion of the adhesive-coated surface 64 that is adhered to the separation surface 42 and rotate the roll 60 by pulling the newly formed leading portion 61 across separation surface 42. It should be understood that more than one stamp at a time can be removed from roll 60 by pulling multiple stamps 62 past separation member 40. The process of separating the stamps from the roll can then be repeated as needed until all desired stamps have been removed from the roll. Once, all desired stamps have been dispensed from the roll, core 70 and sleeve 80 may be removed from the hub member by flexing flanges 24 towards each other. Next, core 70 may be removed from sleeve 80 and core 70 may be disposed of or recycled. A new roll of stamps may be inserted over sleeve 80, which can be inserted onto hub member 20 so that dispenser 10 maybe reused. Thus, dispenser 10 is able to dispense stamps 62 from roll 60 while having a simple design and very few, if any, moving parts.

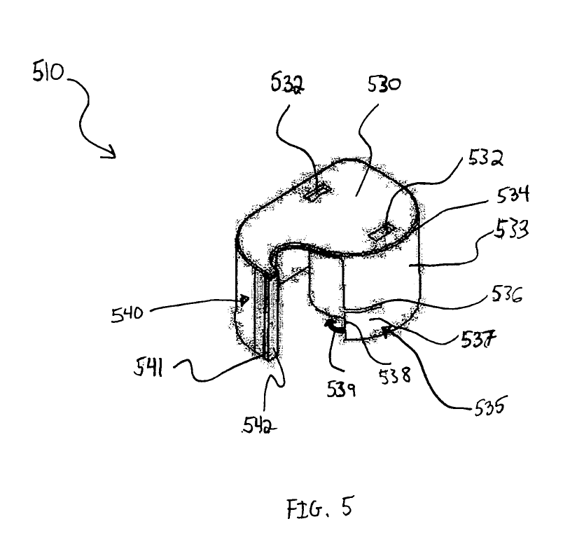

A second embodiment of the dispensing device is shown in FIG. 5, similar in structure and use to the embodiment shown in FIGS. 1-3. The dispensing device 510 includes a wall 530 from which extends a hub member 520 for rotatably mounting a roll 60 of stamps 62 like the roll 60 shown in FIG. 3. Dispensing device 710 includes a separation member 540, a top shield 533, a base, and a rear shield, similar to the embodiment shown in FIGS. 1-3. Hub member 520 also includes flanges for retaining the roll 60 of stamps 62 between wall 530 and flanges. The flanges may have a similar structure to flanges 24 depicted in FIGS. 4A and 4B. Roll 60 may include a core and/or sleeve as described with respect to the embodiment shown in FIGS. 1-3.

The embodiment in FIG. 5 is different from the embodiment depicted in FIGS. 1-3 in that dispenser 510 includes an interference means 535 for preventing roll 60 from unraveling when the user pulls leading portion 61 across separation member 40 and removes one or more stamps from the roll. Interference means 535 comprises a flexible portion or brake 537 opposite to wall 530 defined by a slit 536 in top shield 533. Brake 537 may act as a cantilever member such that its distal end 538 may be flexed in a direction 539 toward the hub member 520. Thus, flexible member 537 is moveable between an engaged position in which the flexible member engages the roll 60 of stamps to prevent the roll from unraveling and an unengaged position in which the flexible member is not engaged with the roll 60 of stamps. In an embodiment, brake 537 is biased towards the unengaged position. Brake 537, as well as the other elements of dispenser 510, may be made of a resilient material, such as plastic, rubber, or the like. The interference means may have other embodiments such as a clutch or a button on wall 530 that can be pressed against roll 60 to impede its rotation about hub member 530.

In operation, the embodiment of dispenser 510 shown in FIG. 5 is similar to that of dispenser 10 shown in FIGS. 1-3. However, in the embodiment shown in FIG. 5, prior to separating overhanging stamp 62 from the roll 60, brake 537 may be pressed toward the hub member 520 until it firmly engages the outer surface of the roll 60. As such, brake 537 prevents the roll 60 from unraveling (in conjunction with the separation surface 540) when the user applies tension to overhanging stamp 62.

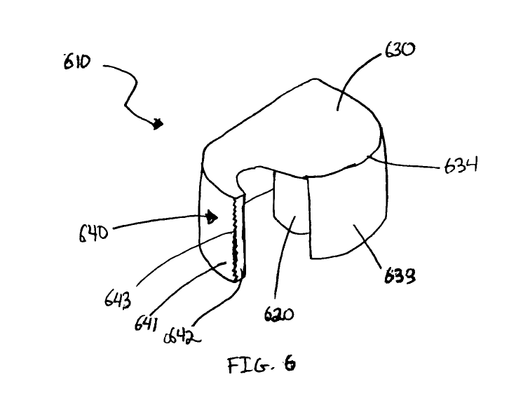

A third embodiment of the dispensing device is shown in FIG. 6. The dispensing device 610 includes a wall 630 from which extends a hub member 620 for rotatably mounting roll 60 of stamps 62 similar to the roll 60 shown in FIGS. 1-3. In addition, dispensing device 610 includes a separation member 640, a top shield 633, a base, and a rear shield, similar to the embodiment shown in FIGS. 1-3. Hub member 620 also includes flanges for retaining the roll 60 of stamps 62 between wall 630 and flanges. The flanges may have a similar structure to flanges 24 depicted in FIGS. 4A and 4B. Roll 60 may include a core and/or sleeve as described with respect to the embodiment shown in FIGS. 1-3. In addition, the embodiment of dispenser 610 shown in FIG. 6 may include an interference means, similar to the interference means described with respect to FIG. 5.

The embodiment in FIG. 6 is different from the embodiment depicted in FIGS. 1-3 in that separation member 640 includes a blunt separation surface 642 and a sharp cutting edge 643. Cutting edge 643 may comprise a blade, serration, teeth, sharp edge, or the like, in order to facilitate separating stamps 62 from roll 60. Cutting edge 643 allows dispenser 610 to be used with a roll of adhesive backed stamps 62 separated from one another by perforations or scores 68, as depicted in FIG. 3, or with rolls of other types of materials. In operation, the embodiment of dispenser 610, shown in FIG. 6, is similar to that of dispenser 10 shown in FIGS. 1-3. However, in the embodiment shown in FIG. 6, cutting edge 643 assists in separating overhanging stamp 62 from the roll 60 by helping to initiate separation along perforation or score 68.

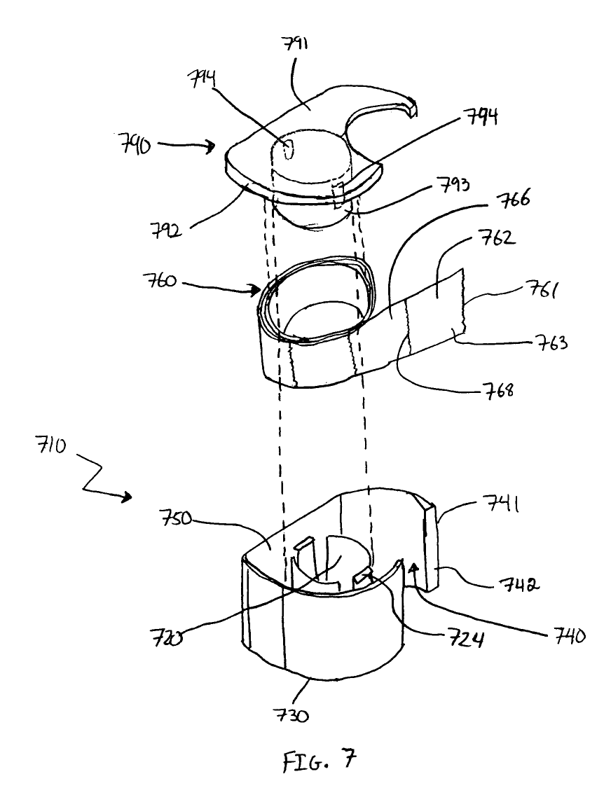

A fourth embodiment of the dispensing device is shown in FIG. 7. The dispensing device 710 includes a wall 730 from which extends a hub member 720 for rotatably mounting roll 760 of stamps 762, similar to the embodiment shown in FIGS. 1-3. In addition, dispensing device 710 includes a separation member 740, a top shield 733, a base 750, and a rear shield 751, similar to the embodiment shown in FIGS. 1-3. Hub member 720 also includes flanges 724 for retaining the roll 760 of stamps 762 between wall 730 and flanges 724. Flanges 724 may have a similar structure to flanges 24 depicted in FIGS. 4A and 4B. Roll 760 may include a core and/or sleeve as described with respect to the embodiment shown in FIGS. 1-3.

The embodiment in FIG. 7 is different from the embodiment depicted in FIGS. 1-3 in that dispenser 710 further includes a cover 790. Cover 790 includes a cover wall 791 that is substantially parallel to and a substantially mirror image of wall 730. Cover 790 further includes depending wall 792 that depends from the perimeter of cover wall 791 in a direction that is substantially perpendicular to cover wall 791. Depending wall 792 is configured to mate with top shield 733, base 750, and rear shield 751 so as to encase roll 760 within dispenser 710. Depending wall 792, top shield 733, base 750, and/or rear shield 751 may be provided with locking mechanisms to releasably lock depending wall 792 to top shield 733, base 750, and/or rear shield 751. For example, depending wall may be provided with a lip that fits into a groove running along top shield 733, base 750, and/or rear shield 751. Other locking mechanisms, such as friction fit, teeth, hooks, or clips may also be used. Accordingly, cover wall 791 may be joined to wall 720 to encase roll 760 of stamps 762 within the dispenser 710.

In addition, cover wall 791 may be provided with a substantially cylindrical hub cover 793 extending substantially perpendicularly from cover wall 791. Hub cover 793 has a hollow interior configured to receive hub member 720 in a mating relationship. In an embodiment, hub cover 792 may include apertures 794 (shown in phantom) for receiving the ends of flanges 724 in a locking relationship. As shown in FIG. 7, roll 760 of stamps may be rotatably mountable about hub cover 793, which in turn may be mounted in a stationary relationship around hub member 720. Alternatively, hub member 720 may have a hollow interior configured to receive hub cover 793 in a mating relationship. In such an embodiment, roll 760 of stamps 762 may be rotatably mounted about hub member 720, which could in turn be mounted in a stationary relationship about hub cover 793. It should be understood that hub member 720 and hub cover 793 may be locked together in a variety of manners such as by friction fit, hooks, teeth, or clips. In addition, the embodiment of dispenser 710 shown in FIG. 7 may include an interference means, similar to the interference means described with respect to FIG. 5.

The operation and use of the embodiment shown in FIG. 7 is similar to the operation and use of the embodiment shown in FIGS. 1-3. Roll 760, which may be wound around a core and placed over a sleeve may be mounted about hub cover 793. Flanges 724 may be flexed towards each other to allow hub cover 793 to be inserted over hub member 720. Once hub cover 793 is in place over hub member 720, flanges 724 may be released as lips of flanges 724 become locked in apertures 794 so that hub cover 793 becomes releasably locked inside hub member 720. At the same time, depending wall 792 of cover wall 790 may be coupled to top shield 733, base 750, and rear shield 751, so as to reversibly lock cover wall 790 to wall 730 to form a housing for roll 760 of stamps.

Roll 760 may be rotated by pulling leading portion 761 of roll 760 across separation member 740, such that at least a first stamp 763 is guided past the separation surface 742 and the succeeding perforation or score 768 is aligned with or slightly over front end 741 of separation member 740. A portion of the adhesive-coated surface of a second stamp 766 is then releasably retained on separation surface 742 while the first stamp 763 overhangs and projects past separation surface 742. The adherence of the second stamp 766 to separation surface 742 is sufficient to allow the user to separate first stamp 763 from the roll along perforation or score 768 by tensioning the leading portion 761 of roll 760 and lightly pulling on overhanging first stamp 763. After first stamp 763 is separated from the roll 760, a new leading portion 761 is formed where the perforation or score 768 was separated. If additional stamps are to be separated from the roll 760, the user may lift the portion of the adhesive-coated surface that is adhered to the separation surface 742 and rotate the roll 760 by pulling the newly formed leading portion 761 across separation surface 742. It should be understood that more than one stamp at a time can be removed from roll 760 by pulling multiple stamps 762 across separation member 740. The process of separating the stamps from the roll can be repeated as needed until all desired stamps have been removed from the roll. Once, all desired stamps have been dispensed from the roll, the empty core and/or sleeve can be removed from the dispenser 710 by pulling cover wall 790 apart from wall 730. A new roll of stamps may then be inserted over hub cover 793 and the dispenser 710 may be reused, as described above.

A number of embodiments of the invention have been described. Nevertheless, it will be understood that various modifications may be made without departing from the spirit and scope of the invention. For example, the devices described herein can be used to separate not only liner-less adhesive-backed stamps separated by perforations or scores, but any adhesively backed material. In addition, the hub member, wall, flanges, and separation member can have any desired configuration. The top shield, base, and rear shield need not extend around the top of the roll; rather these elements can be omitted in whole or in part. The dispenser can be constructed of any suitably stiff and resilient material, such as plastic, metal, and composites. As noted above, the dispenser may be manufactured integrally in a single piece or may be assembled from components. The dispenser can optionally be constructed of a transparent material, such as an amorphous polymer, to facilitate viewing of the roll. Accordingly, other embodiments are within the scope of the following claims.

What is claimed is:

1. A stamp dispenser comprising:
a hub member having a longitudinal axis;
a roll of liner-less adhesive-backed stamps, the roll rotatably mounted about the hub member and including a leading portion comprised of one or more of the stamps; and
a separation member rigidly coupled to the hub member and spaced apart from the hub member to define an access area adapted to permit a user to grasp one or more stamps, the separation member having a separation surface operable to facilitate separating one or more of the stamps from the roll of stamps when the leading portion is tensioned across the separation surface.

2. The stamp dispenser of claim 1, wherein each of the stamps is separated by a perforation.

3. The stamp dispenser of claim 1, wherein each of the stamps is separated by a score.

4. The stamp dispenser of claim 1, further comprising a substantially cylindrical core, wherein the roll of stamps is wound around the core.

5. The stamp dispenser of claim 1, further comprising a sleeve disposed between the roll of stamps and the hub member.

6. The stamp dispenser of claim 1, further comprising a wall having a hub section and a forward extending section, the hub member coupled to the hub section with the longitudinal axis substantially perpendicular to the wall, and the separation member coupled to the forward extending section.

7. The stamp dispenser of claim 6, further comprising one or more flanges coupled to the wall for retaining the roll of stamps between the one or more flanges and the wall.

8. The stamp dispenser of claim 7, wherein each of the one or more flanges comprises a flexible member and a lip configured to retain the roll between the lip and the wall.

9. The stamp dispenser of claim 8, wherein each of the one or more flanges further comprises an extension member extending from the lip and configured to allow a user to flex the flexible member.

10. The stamp dispenser of claim 1, wherein the separation surface is configured to releasably retain at least a portion of the leading portion of the roll.

11. The stamp dispenser of claim 1, wherein the separation surface is substantially free of sharp corners and sharp edges.

12. The stamp dispenser of claim 1, further comprising an interference means for preventing unraveling of the roll of stamps.

13. The stamp dispenser of claim 12, wherein the interference means comprises a brake.

14. The stamp dispenser of claim 13, wherein the brake is reversibly moveable between an engaged position wherein the brake engages the roll of stamps and an unengaged position wherein the brake does not engage the roll of stamps.

15. The stamp dispenser of claim 14, wherein the brake is biased in the unengaged position.

16. A method of dispensing one or more stamps from a substantially cylindrical roll of liner-less adhesive-backed stamps, the roll including a leading portion, the method comprising:
rotatably mounting the roll of stamps about a hub member;
pulling the leading portion across a separation member rigidly coupled to the hub member having a longitudinal axis;
separating the one or more stamps from the roll by tensioning the leading portion of the roll across a separation surface on the separating member.

17. The method of claim 16, wherein the separating step further comprises tearing the one or more stamps along a perforation in the roll.

18. The method of claim 16, wherein the separating step further comprises tearing the one or more stamps along a score in the roll.

19. The method of claim 16, wherein the mounting step further comprises inserting a sleeve between the hub member and the roll.

20. The method of claim 16, further comprising providing a wall having a hub section and a forward extending section, the hub member coupled to the hub section with the longitudinal axis substantially perpendicular to the wall, and the separation member coupled to the forward extending section.

21. The method of claim 20, wherein the mounting step further comprises flexing one or more flanges coupled to the wall, inserting the roll over the hub member, and releasing the one or more flanges to retain the roll between the flanges and the wall.

22. The method of claim 21, wherein each of the one or more flanges comprises a flexible member and a lip configured to retain the roll between the lip and the wall.

23. The method of claim 22, wherein each of the one or more flanges further comprises an extension member extending from the lip to facilitate the flexing step.

24. The method of claim 16, further comprising releasably retaining a portion of the leading portion on the separation surface.

25. The method of claim 16, wherein the separation surface is substantially free of sharp comers and sharp edges.

26. The method of claim 16, further comprising preventing the roll from unraveling by actuating a brake.

27. The method of claim 26, wherein the brake is reversibly moveable between an engaged position wherein the brake engages the roll of stamps and an unengaged position wherein the brake does not engage the roll of stamps.

28. The method of claim 16, wherein the brake is biased in the unengaged position.
